(19) United States
(12) Patent Application Publication
(10) Pub. No.: US 2021/0086229 A1
(43) Pub. Date: Mar. 25, 2021

(54) Method for Applying Graphic Product to Flooring Surface

(71) Applicant: GameTime Wraps, L.L.C., Little Rock, AR (US)

(72) Inventor: Robert L. F. Sahr, Little Rock, AR (US)

(21) Appl. No.: 17/110,930

(22) Filed: Dec. 3, 2020

Related U.S. Application Data
(63) Continuation-in-part of application No. 15/862,051, filed on Jan. 4, 2018, now Pat. No. 10,889,999.

(51) Int. Cl. B05D 7/00

(52) U.S. Cl. CPC B05D 7/574

(57) ABSTRACT

A system and method for installing a graphic design on a flooring surface, where a vinyl decal displaying the graphic design is applied to a flooring surface, which may optionally be pre-sealed prior to vinyl application, and where after application of the vinyl decal flooring surface, one or more layers of sealer are applied to the floor, covering the vinyl decal and the areas surrounding the vinyl decal (thereby providing a permanent or semi-permanent vinyl application), and finally one or more layers of floor finish are applied to the surface to result in a finished floor displaying the graphic design.

### CROSS-REFERENCE TO RELATED APPLICATIONS

This application claims priority to and is a continuation-in-part of U.S. patent application Ser. No. 15/862,051, entitled “Method for Applying Graphic Product to Hardwood Floor” and filed on Jul. 9, 2019. The entirety of such application is hereby incorporated by reference.

### STATEMENT REGARDING FEDERALLY SPONSORED RESEARCH OR DEVELOPMENT

Not applicable.

### BACKGROUND OF THE INVENTION

Participating in and watching sporting events, whether in person or through a televised broadcast, is one of the most widely enjoyed activities in the United States. One sport in particular that people enjoy to watch is basketball. In 2017, over 30 million people attended college basketball games in the United States and millions of others watched these games on television. Given the magnitude of people to whom these games reach, it is no surprise that the teams, schools, and organizations that play and broadcast these games spend a large amount of money making their teams, schools, and gyms visually appealing to the millions of viewers. Teams are constantly working with large apparel companies to design fashion-forward, eye-catching uniforms. Likewise, schools and organizations whose gyms are used to play these games use graphics and decorations to make their gyms stand out from others.

One trend with these gyms is to use floor graphics to show their school's name, logo, or other intricate design. For years, these floor graphics have consisted of painted graphics. These traditional floor graphics are applied to the floor, which are generally made of hard wood such as maple, through a hand-painting process. After hand-painting of the graphics, the paint is sealed to the floor using a clear coat, which increases the permanency of the painted graphic. For years, this hand-painted graphic process was the only known method for achieving permanent graphic products on these flooring surfaces. And while these hand-painted graphics can be suitable for these permanent display requirements, the process for applying the hand-painted graphics can be burdensome. For example, because the graphic is made from paint, the process requires a high amount of “down time” to allow the paint to dry. This “down time” increases the amount of time before the floor can be used. For teams, this could mean missing out on valuable practice time, and for schools or organizations, this could mean missing out on opportunities to use the space for other events. Furthermore, because paint is used, there are some limitations to what colors, shapes, and designs can be used in the floor graphics. In a society that continuously strives for the next best design, these limitations could have a negative impact on the satisfaction of those sports enthusiasts who are showing up for games.

Other methods have been developed for achieving temporary graphic designs on these flooring surfaces. For example, some techniques have been developed for applying temporary decals to the finished top surface of the wooden floor. While these decals offer better color, shape, and design capabilities than does the hand-painted graphic, these decals generally take the general form of a “sticker” in that that a backing layer can be removed from the decal to expose an adhesive layer. The decal can then be applied to the top surface of the finished floor, with the adhesive layer working to adhere the decal to the finished floor. While these methods work for temporary decal placement (for example, a single-game sponsorship advertisement or a weekend tournament logo), because the decals are placed on top of the finished floor, they are susceptible to peeling and are easily removed from the floor's surface. For teams, schools, and organizations that want a permanent design (logo, school name, etc.), this type of decal application is not sufficient.

Furthermore, while traditionally these types of floors have been made from hardwood materials, many gymnasium floors are now being made from synthetic materials. These floors are commonly made from polyurethane (and may be referred to as Resilient Polyurethane Floor, for example) and can offer durability, longevity, color customization, and ease of maintenance. And while there are some differences between these synthetic floors and traditional hardwood surfaces, the ability to place custom graphics on these surfaces is still needed. And as materials used in the manufacturing of gym floors continue to change, a method for application of graphics to any type of flooring surface is necessary.

A product and process that can be used for applying permanent floor graphics in a time efficient manner to any number of flooring types and that can be used for a wide variety of graphic colors, shapes, and designs is needed.

### BRIEF SUMMARY OF THE INVENTION

The present invention is directed to graphics for a flooring surface and in particular to a method for applying a graphic decal to a flooring surface. It is an object of the present invention to provide a method for applying a permanent floor graphic in a time efficient manner. It is also an object of the present invention to provide a method for application of floor graphics in various shapes, sizes, colors, and designs. In particular, the present invention is directed to series of steps for applying a vinyl decal floor graphic to a flooring surface, whereby the use of the specially designed floor sealer and the application of the vinyl decal and other layers in a specific order and specific arrangement results in a permanent floor graphic. This process, for example, can result in floor graphics that remain unblemished and in an aesthetically pleasing condition for years. These and other objects, features, and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a flow diagram showing the steps of the method of applying a permanent decal according to one embodiment of the present invention.

FIG. 2 a schematic showing a representative finished layered graphic configuration resulting from the method of applying a permanent decal according to the preferred embodiment of the present invention.

FIG. 3 is a flow diagram showing the steps of the method of applying a permanent decal according to another embodiment of the present invention.

FIG. 4 is a flow diagram showing the steps of the method of applying a permanent deal according to another embodiment of the present invention.

FIG. 5 is a flow diagram showing the steps of the method of applying a permanent decal according to another embodiment of the present invention.

### DETAILED DESCRIPTION OF THE INVENTION

The present invention is directed to a process for application of a graphic design to a flooring surface and in particular to a method for applying a vinyl decal product to a flooring surface resulting in a substantially permanent floor graphic design. For purposes of convenience, the present invention may be described with reference to application of a vinyl decal graphic to a maple wood floor. It is understood, however, that any decal material may be used and that the surface to which the decal is applied may be any material and is not limited to a floor. As noted above, for example, the flooring surface may be made of synthetic materials.

Generally speaking, the present invention is directed to a method of permanent application of a graphic decal to a flooring surface (of any material). The permanent application of the graphic decal to the flooring surface is facilitated in three basic steps, while other steps may be included to prepare or modify the adherence of the graphic decal to the floor. In any event the three required steps include: (1) application of a graphic decal to a flooring surface (which may be a raw flooring surface or a treated flooring surface), (2) application of at least one sealant layer on the flooring surface over the graphic decal, including on the area of the flooring surface covered by the graphic decal and on the area of the flooring surface around the graphic decal, and (3) application of at least one finishing layer to the flooring surface over the sealant layer. The application of the sealant layer on top of the area covered by the graphic decal and on the area not covered by the graphic decal facilitates the permanent nature of the graphic decal. While these three steps are the most important for achieving the permanent application of the graphic decal to the flooring surface, additional steps may be included, such steps described more fully below.

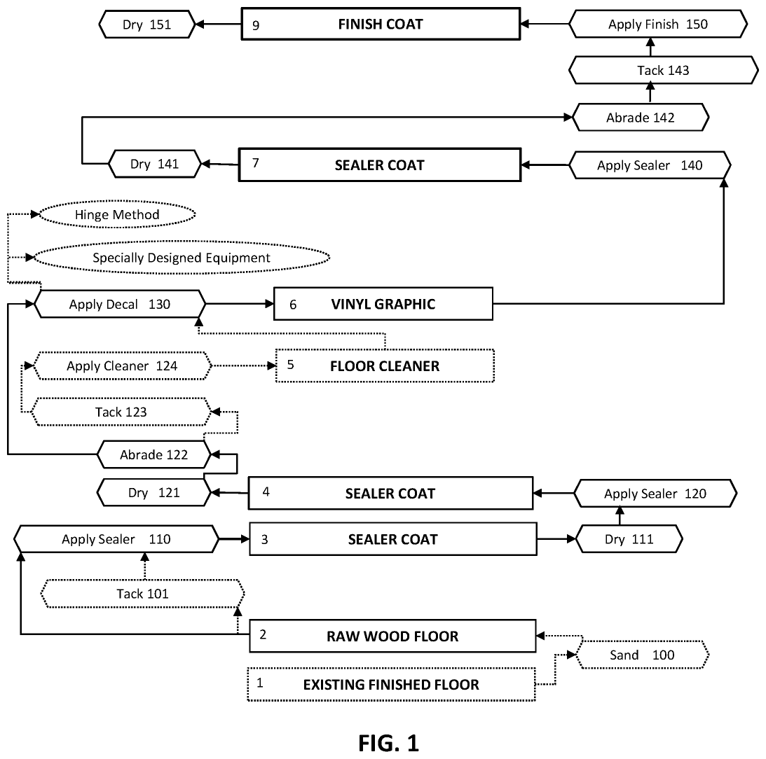

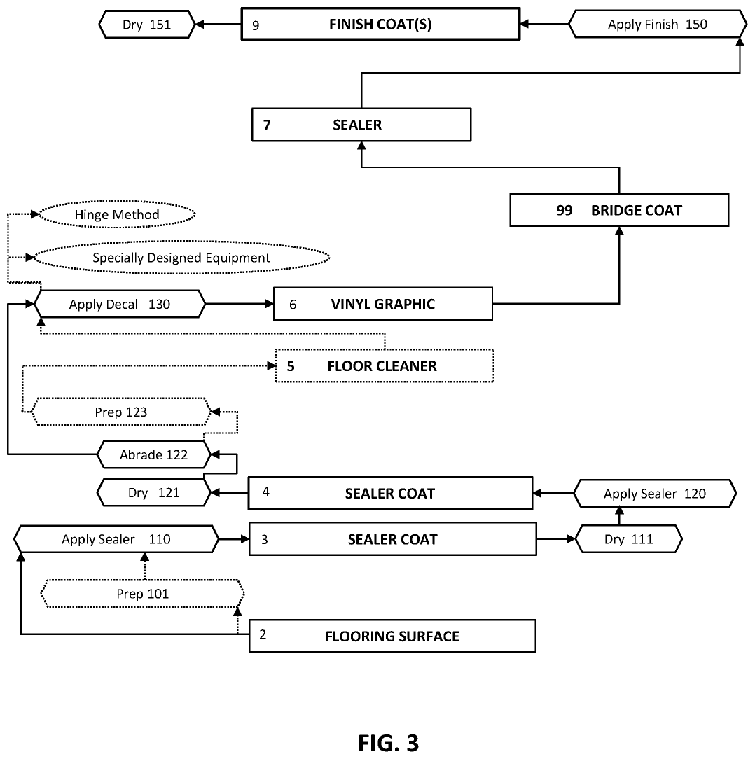

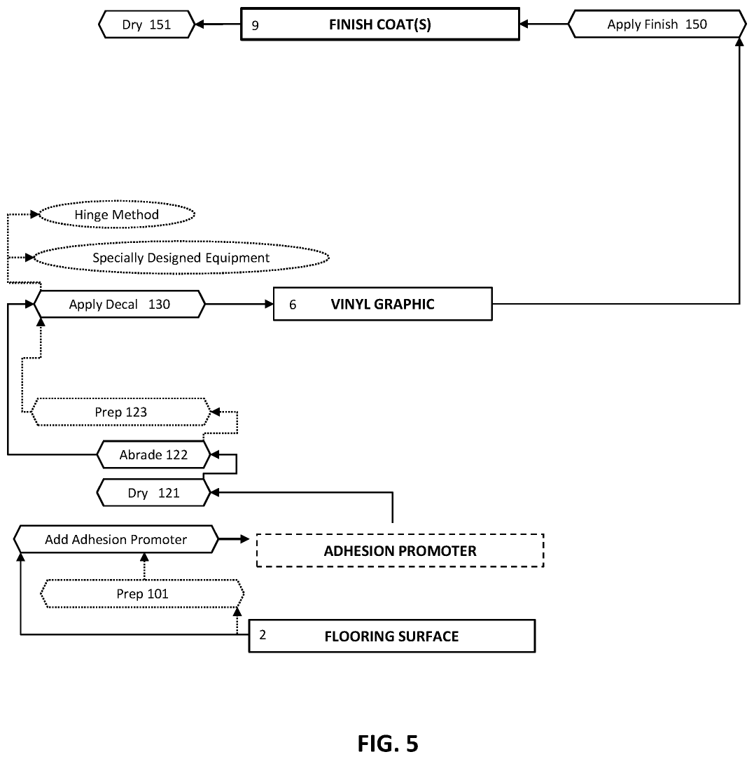

Referring to FIGS. 1 and 3, various methods of application of the graphic design 6 to the flooring surface 2 may be described. Of course, in order to provide a graphic decal to a flooring surface, a flooring surface must be provided. In one embodiment, the process begins with a raw maple wood floor 2 (see FIG. 1). Alternatively, the process may begin with a previously finished wood floor. In yet another embodiment, the flooring surface may be a synthetic material surface or made from any other material that is not wood (for a synthetic surface, for example, the process shown in FIG. 5 may be the most successful embodiment for graphic installation). In some cases, it may be necessary to prep the flooring surface for graphic installation. For example, it may be seen that in the case where the flooring surface is a previously finished wood floor, the flooring surface may be sanded down to provide a raw wood surface. Other means for prepping the flooring surface may be implemented at step 100. For example, the flooring surface 2 may be prepped with the additional steps of screening, cleaning, or tacking to result in a clean, prepped surface. In addition, in one embodiment, the flooring surface 2 may also be screened, cleaned, tacked, or otherwise prepped for graphic application at step 101. In the preferred embodiment, the floor is prepped by tacking the floor with water at step 101.

Once the surface has been prepped for application, the remaining steps of the graphic installment process may begin. As noted above, the steps can be modified depending on application, but of course application of a graphic decal to the surface (whether the raw surface or a treated surface) and the application of at least one sealant layer on the flooring surface after the graphic decal is necessary to achieve the permanent application. In various embodiments, additional sealant layers may be applied before and after the application of the graphic decal as desired.

For example, in one embodiment, a first coat of pre-graphic sealer 3 is applied to the flooring surface 2 at step 110. The sealer 3 is preferably a waterborne polyurethane hybrid, which has unique characteristics sufficient to create a high adhesion between the floor surface 2 and the graphic decal 6 (described below), resulting in an increased permanency of application. Once a first coat of pre-graphic sealer 3 has been applied at step 110, sufficient time should be given to allow the sealer 3 to dry at step 111. In the preferred embodiment, the first coat of sealer 3 should be allowed to dry at step 111 for approximately three to four hours, but shorter or longer drying periods may be required depending on the characteristics of the environment in which the process is being performed. For example, the humidity or temperature of the environment may require shorter or longer drying time at step 111. In one embodiment, after applying the first sealer coat 3 at step 110, one or more additional pre-graphic layers of sealer 4 is applied at step 120. The additional layer(s) of sealer 4 is dried at step 121 in the same manner as the first coat of sealer 3.

Once the desired number of pre-graphic sealant layers (if any) has been applied to the floor and dried for an amount of time depending on environmental factors, the surface of the top coat of sealer 4 is abraded at step 122 to provide a smooth surface for graphic application. In the preferred embodiment, this abrading step 122 is performed using an abrasive pad (which is preferably what is known in the art as a maroon abrasive pad). Alternatively, floor stripping or buffing pads may be used. The sealer coating surface 4 should be abraded such that the grain raise is knocked off, resulting in a smooth even surface for graphic installation. Grain raise typically occurs when water-based coatings are used on wooden surfaces, which results in the wood fibers sticking up from the wood. This screening process allows those fibers to be removed from the surface of sealer coat 4, so that a smooth even surface is provided for the graphic application. The surface of sealer layer 4 may also be tacked at step 123 to further result in a smooth even surface for graphic application.

After application 120 and drying 121 of the pre-graphic sealer layers 3, 4 (if any), and the abrading 122 and tacking 123 of the top pre-graphic sealer layer 4, the next step is to apply at step 130 the graphic design 6 itself to the flooring surface 2. Alternatively, if no pre-graphic sealing layers are used, the vinyl graphic can be applied directly to the flooring surface. This of course would not be preferable because the pre-graphic sealing layers provide for a more efficient adherence of the graphic to the floor, but nevertheless, the graphic can be applied without the pre-graphic sealing layers if desired. In any event, in the preferred embodiment, a vinyl graphic decal 6 is used and applied to either the pre-graphic sealant layer(s) or the flooring surface. The vinyl graphic decal 6 is designed and manufactured off site according to the specifications provided by the school, organization, team, or other intended user. Use of a vinyl graphic 6 allows for a multitude of various designs, colors, and shapes that are difficult, if not impossible, to achieve using hand-painted graphics. For example, a vinyl product allows for intricate designs that use blended colors with seamless transitions and may even be used to provide graphics with somewhat “three-dimensional” optical characteristics. The use of the vinyl product 6 also drastically reduces the application time, from weeks to days or even hours. Generally speaking, the vinyl decal 6 used in this application process has various components, including a design layer (the vinyl graphic layer) and a peel-off backing layer, which when peeled off of the vinyl layer exposes an adhesive that can be used to provide a more permanent adhesion to the surface. Once the back layer is removed, the vinyl graphic 6 is lined up with premeasured floor markings for placement.

The vinyl graphic decal 6 can be applied in any location on the top sealant layer (if any) or directly to the flooring surface 2, and can be used to create center-floor logos or even be used for marking the out-of-bounds, free-throw, or three-point lines on a basketball court. Decal application step 130 may vary slightly depending on unique characteristics of the desired graphic design. For example, for designs requiring the use of larger vinyl decal graphics 6, a “wet application” process may be used. This wet application process utilizes cleaner 5 and an applicator (which for example, may be a squeegee applicator), to apply 124 the cleaner 5 only to the portion of the flooring surface 2 the graphic 6 will be covering. Once this cleaner layer 5 is applied to the surface at step 124, the vinyl decal 6 is ready to be applied at step 130.

After placement of the vinyl graphic 6 in the appropriate location corresponding to pre-marked measurements, a means for eliminating any air and cleaner 5 from between the vinyl layer 6 and the top pre-graphic sealant layer on the floor surface 2 is used to flatten out the edges of the vinyl graphic 6 such that the graphic 6 is arranged in a smooth, even plane on the floor surface 2. For example, a squeegee or other device can be used to push the air and cleaner out, working in a side-to-side manner or middle-to-edge manner. In some instances, particularly for oversized vinyl graphic application, a “hinge” method of application may be used. In this case, the center of the graphic 6 is first held in place on the appropriate floor location and only a portion of the vinyl graphic 6 is applied at a time. That is, for example, only a portion of the back layer of the graphic 6 is removed, and only that portion of the graphic 6 is adhered to the flooring surface 2. Once the application of the first portion is complete, the process can be repeated for the remaining portion of the graphic 6.

In addition to variations in the application process depending on size of the graphics 6, the application process may also slightly vary depending on the type of graphic 6 being applied. For example, while the application steps described above may be better suited for application of larger graphics 6 such as logos, a slight modification of the process may be needed to apply the “game lines” or other non-logo graphics. For example, basketball courts have straight lines marking the outer boundaries of the court and other lines marking the free-throw line, three-point line, “paint” area under the goal, and center court lines. Because these lines are merely straight or circular lines (instead of large intricate designs used for logos), a modified application process must be used. That is, while the overall process is similar in that vinyl graphics 6 are applied to a floor surface 2, the particular steps for installing the vinyl graphic 6 to the surface 2 may be slightly different. In one embodiment, a specially designed game line applicator device (described below) may be used instead of the “wet apply” or “hinged” method described above for larger graphics.

This specially designed game line application is preferably a machine equipped with heavy duty polyurethane wheels and bearings of approximately one-half inch, allowing the device to have the capability of high rpms up to three-hundred pounds. The device uses a vinyl spool as the graphic applicator and may optionally have an extension for improving mobility and usability of the device, such that, for example, the device can be used by a user in the upright, walking position. A laser is mounted to the front of the device, allowing the user to apply the vinyl decal in the appropriate position. Vinyl is spooled around the roller and applied to the floor with the correct pressure to adhere the vinyl to the floor. A secondary polyurethane roller may also be mounted to the device. This device allows the application of vinyl decals in straight lines without requiring extensive measuring or other time-consuming processes required with hand-painted graphics. Curved or circular lines (for example, three-point lines on basketball courts) can also be applied with this process with slight modifications. After application of the sealer to the flooring surface, an applicator device having an arm of a fixed or customizable radius is used to apply these curved lines to the floor surface. A double-spooled apparatus attached to the applicator's arm is used to apply the vinyl at the appropriate radius or distance from a central anchor point.

After application 130 of the vinyl decal 6 to the flooring surface 2 (which may include pre-graphic sealant layers as described above) according to one of the various application procedures discussed above, the vinyl decal 6 is installed on the flooring surface 2, but further steps are necessary to enhance the permanency of the graphic 6 (whether it is a logo or some other design or simply straight or curved lines needed to play the game). First, a post-graphic sealer coat 7 is layered over the flooring surface 2 at step 140, on both the area covered by the vinyl graphic 6 and the non-covered areas (as in general, the vinyl graphic 6 covers only a portion of the flooring surface 2). That is, the coating of this post-graphic sealer 7 is applied directly to the vinyl graphic 6 and to the surrounding areas of the flooring surface 2, such that the post-graphic sealer 7 extends over the edges of the vinyl graphic 6, increasing the permanency of the graphic installment. In the preferred embodiment, only a single additional coat of post-graphic sealer 7 is required, but additional post-graphic sealant layers can be added if desired. As with the previous coats of pre-graphic sealer 3, 4, sufficient time should be given to allow each post-graphic sealer coating 7 to dry at step 141, with three to four hours being the preferred time, depending on environmental conditions. After drying in step 141, the top post-graphic sealer layer 7 should be abraded at step 142 in the same manner described above.

Once the vinyl graphic 6 has been applied to the flooring surface 2 and the layer or layers of post-graphic sealer 7 have been applied, a final floor finishing product 9 is applied at step 150 to the surface 2 to create the permanent graphic result. As with the post-graphic sealer layer(s) 7, the floor finish should be applied at step 150 to the area of the flooring surface 2 covered by the vinyl graphic 6, along the edges of the vinyl graphic 6, and to the remaining area of the flooring surface 2 that is not covered by vinyl graphic 6. This increases the permanency of the vinyl graphic installation. The finish may be, for example, a polyurethane finish, a clear-coat finish, or any other final, game-ready layer.

Furthermore, the finishing product 9 applied at step 150 can vary depending on desired characteristics. For example, an oil based poly finish or a water-based finish may be used. A water-based finish may be desired in time sensitive applications, as water-based finishes typically require less drying time (step 151) than oil based finishes. Furthermore, multiple layers of water-based finishing may be applied without requiring intermittent abrasive screening steps, as a hot coating technique is possible with water-based finishing. Oil based finishing, on the other hand, requires at least several hours of drying time at step 151 preferably allowing for an over-night drying period. The preferred vinyl application process uses one coat of post-graphic sealer 7 and one coat of finish 9, but multiple coats of post-graphic sealant layers 7 and multiple coats of finish 9 may be applied if desired. The preferred finisher for use in the finishing application process 150 is a waterborne finish with high solid contents (preferably approximately 50%, but other solid contents may also be used, such as approximately 30% or any other solid contents), which allows the finish application process 150 to be implemented using only a single coating of finish 9. With the use of this quick finishing process 150 in addition to the lower time demands of the sealer application and vinyl decal application, a permanent graphic design can be applied to a surface in approximately half the time it takes for traditional hand-painted processes. After application 150 of the finish coat 9 (or multiple finish coats) and after sufficient drying of the finish coat(s), the floor with graphic design is ready for use.

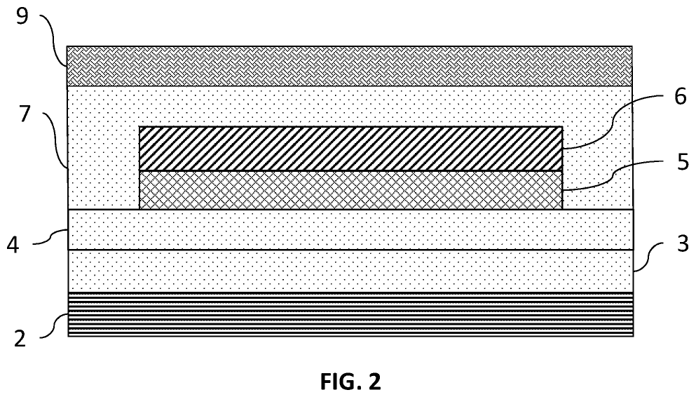

One exemplary configuration of the layers following application is represented by the schematic shown in FIG. 2. This schematic represents a representative cross-section of a fully installed graphic decal 6 according to one embodiment of the method described above. As shown, one or more pre-graphic sealer layers 3, 4 are coated on a flooring surface 2. A cleaner 5 is applied to the top pre-graphic sealer layer 4 and a vinyl decal 6 having the graphic design is applied over the cleaner 5. In the preferred embodiment, excess cleaner 5 is removed from beneath the vinyl decal 6 by application of pressure to the top of the applied vinyl decal 6. After application of the vinyl decal 6, one or more post-graphic sealer layers 7 are applied to the area covered by the vinyl decal 6 and to the areas not covered by the vinyl decal 6. The overlapping of the sealer on the vinyl decal 6 and the area uncovered by the vinyl decal 6 increases the permanency of the vinyl decal 6. Finally, a finish layer 9 is also applied to the entire area, both the area covered by the decal 6 and the area uncovered by the decal to increase the permanency of the design.

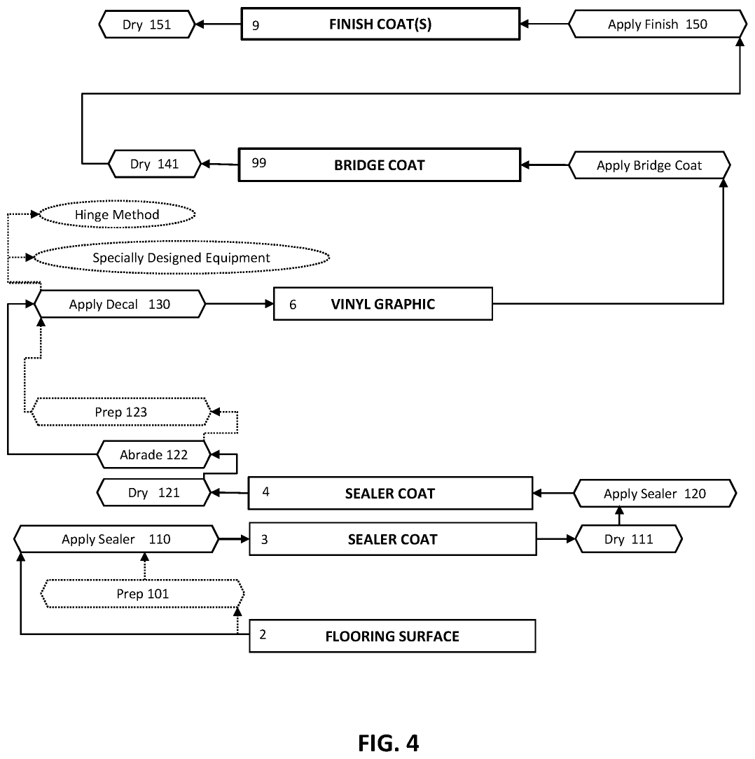

In one embodiment, it may be seen that an additional layer of product is used between the vinyl decal 6 and the first post-graphic layer of sealer 7. For example, where the specific sealer 7 used is of a material insufficient to properly adhere to the vinyl decal 6, a product that acts as a “bridge” 99 between the decal 6 and sealer layer 7 may be used (as shown in FIG. 3, for example). Alternatively, it may be seen that the bridge coat 99 may be used where no post-graphic sealer layers are used at all (see FIG. 4, for example). In this case, the bridge coat 99 is applied directly to the vinyl graphic 6 and is positioned between the vinyl graphic 6 and the finish coats 9. Finally, in one embodiment (particularly in cases where the flooring surface 2 is a synthetic flooring surface), it may be seen that a vinyl graphic layer 6 can be applied directly to the flooring surface 2 without any sealing layers and the finish coat 9 (which may be, for example, a clear-coat finish) is applied directly to the vinyl graphic 6 and to the area beyond the perimeter of the vinyl graphic 6 to achieve the desired permanent decal on the synthetic flooring surface 2. In this regard, the clear-coat finish layer acts as both the sealing layer and the finish layer, both sealing the graphic to the floor and acting as the final layer for game-ready playing. While an adhesion promoter may be utilized between the flooring surface and the vinyl graphic, such step is not necessary to achieve the desired results.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention, as set forth in the appended claims.

1. A method for installing a graphic design on a flooring surface, the method comprising the steps of:
a. applying a vinyl decal on at least a portion of the flooring surface, wherein the vinyl decal comprises a perimeter and wherein the graphic design is positioned within the perimeter of the vinyl decal;
b. applying a first coat of a sealer both on the portion of the flooring surface covered by the vinyl decal and on an area of the flooring surface beyond the perimeter of the vinyl decal;
c. drying the first coat of the sealer to create a first sealed surface covering both the area of the flooring surface covered by the vinyl decal and the area of the flooring surface beyond the perimeter of the vinyl decal; and
d. applying at least one coat of a finish to the first sealed surface to create a finished surface covering both the portion of the flooring surface covered by the vinyl decal and the area of the flooring surface beyond the perimeter of the vinyl decal.

2. The method of claim 1, wherein the sealer is a waterborne polyurethane hybrid.

3. The method of claim 1, wherein the finish is an oil-based poly finish.

4. The method of claim 1, wherein the finish is a water-based finish.

5. The method of claim 1, further comprising the step of applying a bridge coat after applying the vinyl decal and before applying the first coat of sealer.

6. The method of claim 1, further comprising the step of applying a second coat of the sealer after applying the first coat of the sealer and before applying the first coat of the finish.

7. The method of claim 1, further comprising the step of applying a first pre-vinyl coat of the sealer to the flooring surface before applying the vinyl decal to the flooring surface.

8. The method of claim 7, further comprising the step of applying a second pre-vinyl coat of the sealer to the flooring surface before applying the vinyl decal to the flooring surface.

9. The method of claim 1, wherein the flooring surface comprises a hardwood floor.

10. The method of claim 1, wherein the flooring surface comprises a synthetic floor.

11. A method for installing a graphic design on a flooring surface, the method comprising the steps of:
a. applying a vinyl decal on at least a portion of the flooring surface, wherein the vinyl decal comprises a perimeter and wherein the graphic design is positioned within the perimeter of the vinyl decal;
b. applying a first coat of a bridging product both on the portion of the flooring surface covered by the vinyl decal and on an area of the flooring surface beyond the perimeter of the vinyl decal;
c. applying at least one coat of a finish to create a finished surface covering both the portion of the flooring surface covered by the vinyl decal and the area of the flooring surface beyond the perimeter of the vinyl decal.

12. The method of claim 11, further comprising the step of applying a first pre-vinyl coat of the sealer to the flooring surface before applying the vinyl decal to the flooring surface.

13. The method of claim 12, further comprising the step of applying a second pre-vinyl coat of the sealer to the flooring surface before applying the vinyl decal to the flooring surface.

14. The method of claim 11, wherein the flooring surface comprises a hardwood floor.

15. The method of claim 11, wherein the flooring surface comprises a synthetic floor.

16. A method for installing a graphic design on a synthetic flooring surface, the method comprising the steps of:
a. applying a vinyl decal on at least a portion of the synthetic flooring surface, wherein the vinyl decal comprises a perimeter and wherein the graphic design is positioned within the perimeter of the vinyl decal;
b. applying at least one coat of a finish to the portion of the synthetic flooring surface covered by the vinyl decal and on an area of the flooring surface beyond the perimeter of the vinyl decal to create a finished synthetic flooring surface with a permanent graphic design.

17. The method of claim 16 further comprising the step of applying an adhesion promoter to the synthetic flooring surface prior to applying the vinyl decal to the synthetic flooring surface.
